(19) United States
(12) Patent Application Publication
(10) Pub. No.: US 2009/0187779 A1
(43) Pub. Date: Jul. 23, 2009

(54) AUTOMATIC POWER MANAGEMENT METHOD

(75) Inventors: Chuan Liu, Hsinchu City (TW); Chien-Hsun Tung, Taichung City (TW); Jeng-Horng Tsai, Kao-Hsiung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/016,272

(22) Filed: Jan. 18, 2008

(51) Int. Cl. G06F 1/32

(52) U.S. Cl. 713/323; 713/320

(57) ABSTRACT

The application discloses methods applied to an electronic system capable of operating in a non power saving mode and a power saving mode. According to one of the methods, the idle time when the electronic system is idle in the non-power saving mode is measured. If the idle time equals or exceeds a mode entry time, the electronic system enters the power saving mode. The power down duration when the electronic system stays in the power saving mode is measured. The mode entry time is then modified based upon the power down duration.

### BACKGROUND OF THE INVENTION

1. Field of the Invention

The invention generally relates to power management and in particular to methods of automatic power management for devices integrating a serial bus interface.

2. Description of the Related Art

A SATA (serial advanced technology attachment) bus or a SAS (serial attached SCSI) bus, which is a serial bus that is expected replacing parallel interface in storage device, is primarily designed for data transfer between two SATA/SAS compatible device, such as a host (a computer for example) and a storage device (an optical disc drive for example). The SATA bus has at least three advantages over the parallel ATA bus, namely speed, cable size and hot-plug capability. The SATA bus comprises a pair of signal lines connected to a differential transmitter configured to transmit signals in one direction and another pair of signal lines connected to another differential transmitter configured to transmit signals in an opposite direction.

In the SATA interface standard, a physical layer, a link layer and a transport layer are defined. The physical layer executes high-bit-rate serial data transmission and reception. The data received by the physical layer is de-serialized and transmitted to the link layer. The physical layer also receives the data from link layer, serializes the data and outputs the serial data to a differential line pair. The link layer supplies the physical layer with a request to output a signal and supplies the transport layer with the data transmitted from the physical layer. The transport layer performs data conversion for operation based on ATA standards.

The SATA specification is applied to the transmission interface of a hard disc drive or an optical disc drive to replace parallel ATA/ATAPI interface that has been used for a long time. The SATA interface specification specifies two pairs of differential signal lines to replace the original 40 or 80 signal lines connected in parallel. Serializing the original data can reduce the size and voltage and increase the speed. The specification also introduces some new functions, such as flow control and error resending, to control the data stream in a simple way.

FIG. 13 is a schematic illustration showing communication layers in the SATA specification. As shown in FIG. 13, the SATA interface connects a host 11 to a device 13. The device 13 may be an optical storage device or a hard disc drive, or other devices with the SATA interface. The communication layers in the SATA specification include four layers, which are respectively a first layer (physical layer), a second layer (link layer), a third layer (transport layer) and a fourth layer (application layer). The physical layer is responsible for converting digital and analog signals. That is, the physical layer receives and converts a digital signal sent from the link layer into an analog signal and transmits the analog signal to the other end. The physical layer also receives and converts the analog signal, which comes from the other end, into a digital signal and outputs the digital signal to the link layer. The link layer encodes and decodes the digital data. That is, the link layer encodes the data coming from the transport layer and outputs the encoded data to the physical layer. On the other hand, the link layer decodes the data coming from the physical layer and outputs the decoded data to the transport layer. Besides that, link layer also supports power down management. The transport layer constructs and deconstructs the FIS (Frame Information Structure). The detailed definition of the FIS can be found in the SATA specification. The application layer is in charge of buffer memory and DMA engine(s).

SATA interface standards support PhyReady mode, Partial mode and Slumber mode. The PhyReady (Idle) mode indicates a state when a SATA interface is ready to transmit and receive data. Such that the PHY (physical) logic for realizing the operation of the physical layer and the main phase-lock loop (PLL) circuit for synchronizing both of the SATA compatible devices are both powered on and active. The Partial mode and the Slumber mode are power saving modes, eliminating or reducing the power consumed by PHY logic and/or the power consumed by the main PLL circuit. The Slumber mode is saving more power than the Partial mode, but the return latency is different. The return latency from the Partial mode is generally no longer than 10 μs (microseconds) while that from the Slumber mode is generally no longer than 10 ms (milliseconds).

FIG. 14 shows the power management of a SATA interface standard. Primitive “Partial Request” (PMREQ_P) or primitive “Slumber Request” (PMREQ_S) may be sent to a SATA bus, by one of the SATA compatible devices, to render connected SATA interfaces entering Partial mode or Slumber mode, respectively. To resume from Partial or Slumber mode to the PhyReady mode, either the host or the storage device sends OOB (out of band) signal COMWAKE to the serial bus, then the host or the storage device response the COMWAKE and is switched to the PhyReady mode.

Typically, the SATA compatible devices request a power mode transition immediately after all outstanding commands have been completed. This allows the link to enter a low-power state immediately upon completion of the commands. But, before the outstanding commands have been completed, there might have some idleness in the link, such as waiting transmitting or receiving data or state information before the completion of the command. During the idleness the SATA compatible devices only receiving or transmitting a synchronization signal.

### BRIEF SUMMARY OF THE INVENTION

An embodiment of the invention provides a method applicable to an electronic device with a serial bus interface. The electronic device is connected to another electronic device through a serial bus, and the serial bus interface has an internal queue to store outstanding commands. When the internal queue is empty, the electronic device enters a power saving mode.

Another embodiment of the invention provides a method applicable to an electronic device with a serial bus interface. The electronic device is connected to another electronic device through a serial bus, and the electronic device comprises a link layer portion and a physical layer portion. It is determined whether the serial interface is idle. The electronic device enters a power saving mode when the serial interface is idle.

Another embodiment of the invention provides a method applied to an electronic system capable of operating in a non power saving mode and a power saving mode. Measuring an idle time of the electronic system in the non-power saving mode, when the idle time is equal to or exceeds a mode entry time, the electronic system enters the power saving mode. Measuring a power down duration during the electronic system in the power saving mode, and the mode entry time is been modify according to the power down duration.

The serial bus interface would be a SATA or SAS interface. An idle SATA bus also means primitive SYNC on SATA bus.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram illustrating a system with a host and a optical disc drive (ODD) communicating through a SATA bus according to an embodiment of the invention;

FIGS. 2a and 2b are flowcharts of two methods of automatic power management for SATA compatible devices in FIG. 1;

FIG. 3 is a block diagram illustrating another system with a host and an ODD communicating through a SATA bus according to an embodiment of the invention;

FIGS. 4a and 4b are flowcharts of two methods of automatic power management for SATA compatible devices in FIG. 3;

FIG. 5 is a flowchart of a method of automatic power management for a SATA compatible device according to embodiments of the invention;

FIGS. 6-12 exemplify step 512 in FIG. 5;

FIG. 13 a schematic illustration showing communication layers in the SATA specification; and

FIG. 14 shows the power management for a SATA standard interface.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

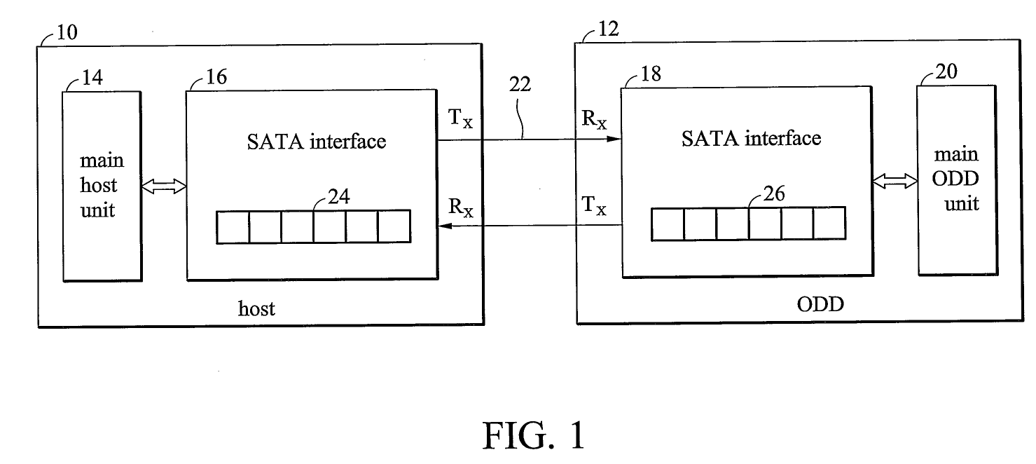

FIG. 1 is a block diagram illustrating a system with a host, such as a personal computer, and a storage device, such as an optical disc drive (ODD), communicating through a SATA bus according to an embodiment of the invention. Both of the host and the optical disc drive are SATA compatible devices. As shown, host 10 comprises a main host unit 14, a SATA interface 16, a transmitter module Tx for transmitting information and a receiver module Rx for receiving information and storage device 12 comprises a main ODD unit 20, a SATA interface 18, a transmitter module Tx for transmitting information and a receiver module Rx for receiving information. Both SATA interfaces 16 and 18 convey data to each other via a SATA bus 22 disposed there between. Each SATA interface (16 or 18) comprises an internal queue (24 or 26) in which commands are dynamically rescheduled and reordered, such that SATA interfaces 16 and 18 both support Native Command Queuing (NCQ), a command protocol for SATA permitting multiple outstanding commands within a drive, or native AT Attachment Packet Interface (ATAPI) command, a command protocol for SATA permitting outstanding packet command in a single SATA Framed Information Structure (FIS).

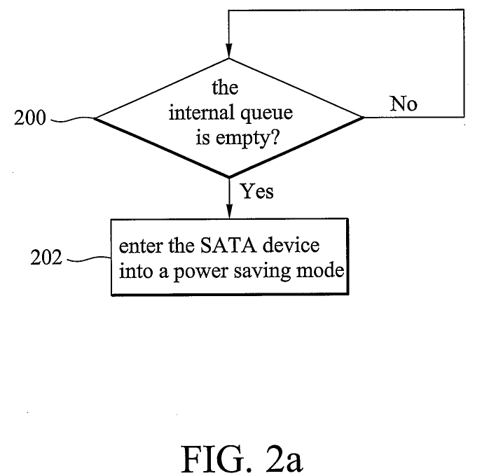

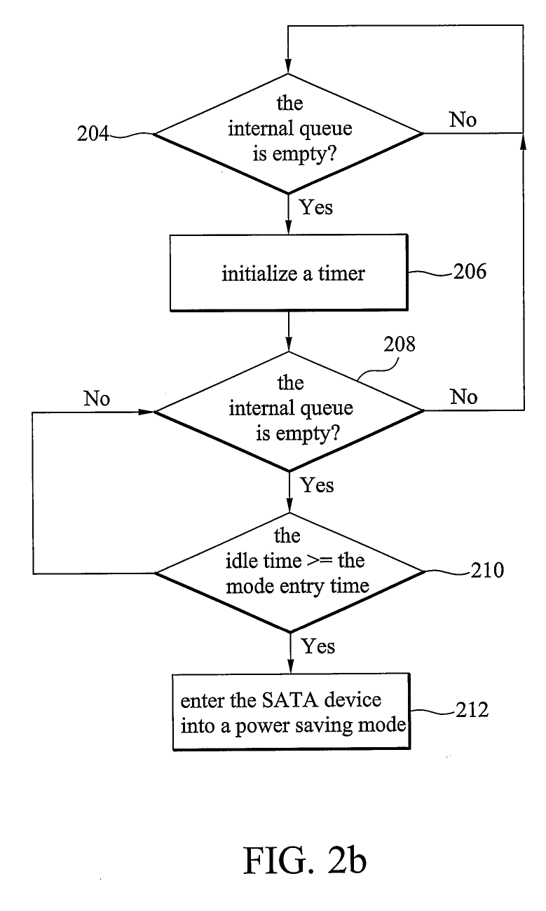

FIGS. 2a and 2b are flowcharts of two embodiments of automatic power management for the host 10 and the storage device 12 in FIG. 1 according to the invention. As shown, a SATA interface is determined to be “idle” if its internal queue is empty. Either SATA host or SATA compatible storage device may determine the SATA interface to be idle, respectively. Hereinafter, for the sake of brevity, only storage device 12 integrating SATA interface 18 of FIG. 1 is exemplified to perform the steps in FIGS. 2a and 2b, although the steps are equally applicable to host 10 integrating SATA interface 16. It is determined whether internal queue 26 is empty in step 200 of FIG. 2a. If so, SATA interface 18 is considered idle. And then storage device 12 is switched to operate in a power saving mode, as indicated in step 202 in FIG. 2a. The mode change can be accomplished by transmitting a “Partial Request” or a “Slumber Request” to SATA bus 22.

Alternatively, entry into power saving mode can be delayed until the idle condition continues for a predetermined time, as disclosed in FIG. 2b. Similar to step 200 in FIG. 2a, step 204 of FIG. 2b determines whether internal queue 26 is empty. If so, in step 206, a timer is initialized to calculate an idle time when internal queue 26 is continuously empty. Steps 208 and 210 form a loop continuously determining whether SATA interface 18 remains idle for a mode entry time. If not, “No” route in step 210, the loop is returned to step 208. If the idle time is greater than or equal to the mode entry time, “Yes” route in step 210, storage device 12 enters a power saving mode, as indicated in step 212 in FIG. 2b.

Switching the SATA compatible devices into the power saving mode may include switching the SATA interface 16 or 18 of the SATA compatible device into the power saving mode by transmitting a “Partial Request” or a “Slumber Request” to SATA bus 22. Alternatively, it may include switching the main host unit 14 or the main ODD unit 20 of the SATA compatible device to the power saving mode, such as turn down the rotation speed of the storage device 12 or other likes. Further, it may include turning off the receiver module, and power on the receiver module periodically to check whether the SATA compatible device is request to return to active mode during operating in the power saving mode. Or, it may include any combinations of above mentioned manners to switch the SATA compatible device into the power saving mode.

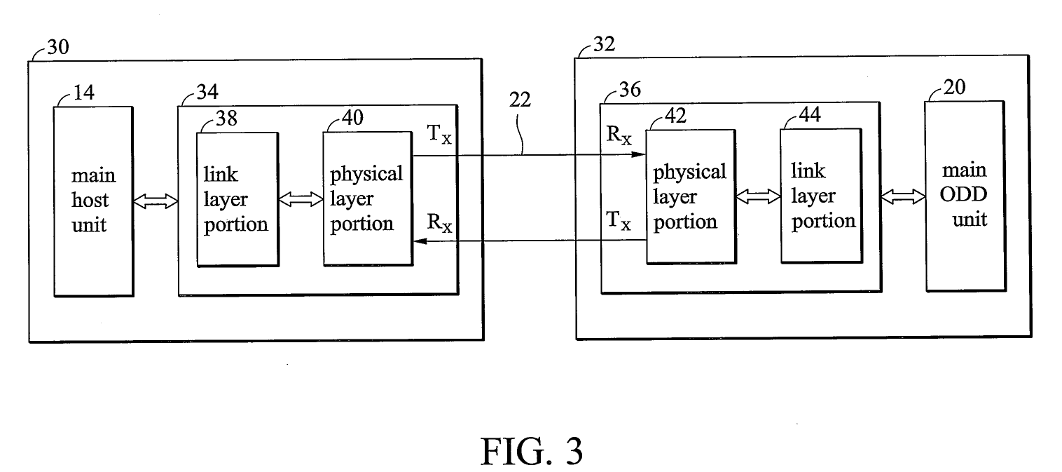

FIG. 3 is a block diagram illustrating a system with a host 30 and an optical disc drive 32 communicating through a SATA bus according to another embodiment of the invention. FIG. 3 employs the same symbols as FIG. 1 for like elements with the same functions. Unlike FIG. 1, SATA interface 34 here has a link layer portion 38 and a physical layer portion 40 and SATA interface 36 has a link layer portion 44 and a physical layer portion 42. Physical layer portion 40 couples the SATA bus 22 to transmit data to or receive data from physical layer portion 42. While the communication between physical layer portion 40 and link layer portion 38 is performed, physical layer portion 40 performs data transmission or reception via the SATA bus 22. If not, physical layer portion 40 is idle, sending a synchronization signal to and receiving another synchronization signal from physical layer portion 42 in SATA interface 36.

An idle condition of the physical layer portion 42 can be also found if there is no communication between a transportation layer portion and link layer portion 38. An idle link layer portion, which is not communicating with a physical or transportation layer portion, implies the idle condition of the SATA interface 34 or 36. Alternatively, an idle condition of the SATA interface can also found while the SATA interface 34 or 36 receiving or transmitting the synchronization signal.

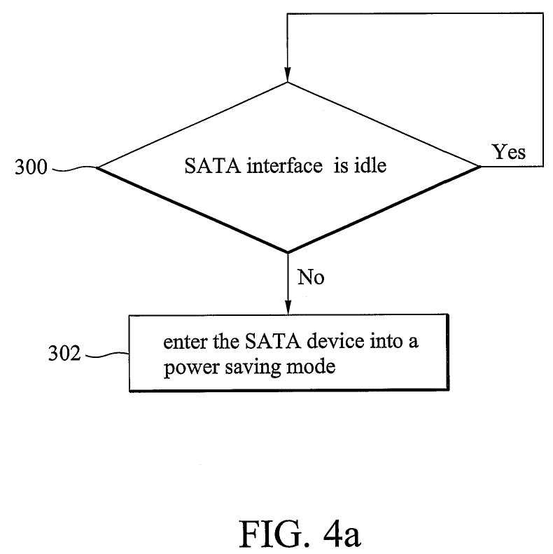

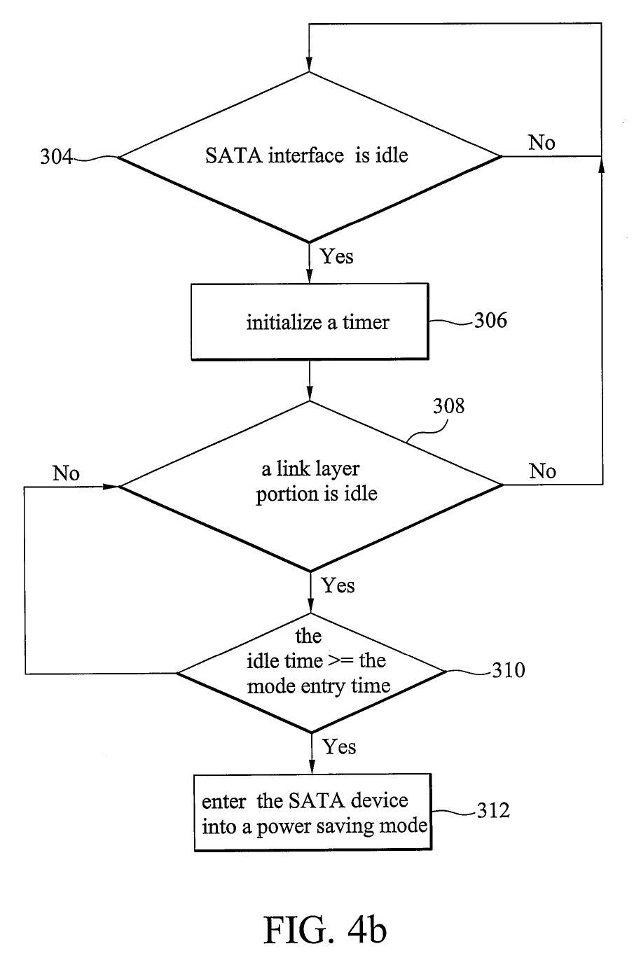

FIGS. 4a and 4b are flowcharts of two embodiments of automatic power management for host 30 or optical disc drive 32 in FIG. 3 according to the invention. In FIGS. 4a and 4b, SATA interface 34 or 36 is determined to be “idle” if a physical layer portion 40 or 42 is idle. Hereinafter, for the sake of brevity, only ODD 32 integrating SATA interface 36 of FIG. 3 is exemplified to perform the steps in FIGS. 4a and 4b, although the steps in FIGS. 4a and 4b are equally applicable to host 30 integrating SATA interface 34. If link layer portion 44 is idle or the SATA interface 36 receiving or transmitting the synchronization signal, SATA interface 36 is considered idle. And then optical disc drive 32 is switched to operate in a power saving mode, as indicated in step 302 in FIG. 4a. The mode change can be accomplished by transmitting a “Partial Request” or a “Slumber Request” to SATA bus 22.

Alternatively, entry into power saving mode can be delayed until the idle condition continuous for a predetermined time, as disclosed in FIG. 4b. Similar to FIG. 2b, besides the determination step of step 304 in FIG. 4b differs from step 204 of FIG. 2b, the other steps perform similar operations. Thus it is not described in detail for the sake of brevity. FIG. 4b shows SATA compatible device is switched to operate in a power saving mode when the SATA interface has been idle over a mode entry time.

Switching the SATA compatible devices into the power saving mode may include switching the SATA interface 34 or 36 of the SATA compatible device into the power saving mode by transmitting a “Partial Request” or a “Slumber Request” to SATA bus 22. Alternatively, it may include switching the main host unit 14 or the main ODD unit 20 of the SATA compatible device to the power saving mode, such as turn down the rotation speed of the storage device 32 or other likes. Further, it may include turning off the receiver module, and power on the receiver module periodically to check whether the SATA compatible device is request to return to active mode during operating in the power saving mode. Or, it may include any combinations of above mentioned manners to switch the SATA compatible device into the power saving mode.

The mode entry time introduced in FIGS. 2b and 4b may be a constant or variable dependent upon the specific environment encountered by the SATA bus. A SATA compatible device moving from a non-power saving mode to a power saving mode implies the SATA compatible device entering power saving mode, and on the contrary the SATA compatible device entering an active mode. Thus, mode entry time is a period of time from a SATA interface being determined in an idle condition to entering the SATA compatible device to the power saving mode. A power down duration is defined as a period of time from the SATA compatible device entering the power saving mode to returning to the active mode. If power down duration of a SATA compatible device tends to be relatively short, the SATA compatible device may simply remain active to avoid the frequently return latency caused by rapidly being woken from power saving mode, so the mode entry time is preferably increased. Conversely, if the power down duration of a SATA compatible device is relatively longer, earlier entry to the power saving mode may save more power, so the mode entry time should be decreased. Thus, power down duration can be an indicator for modifying mode entry time.

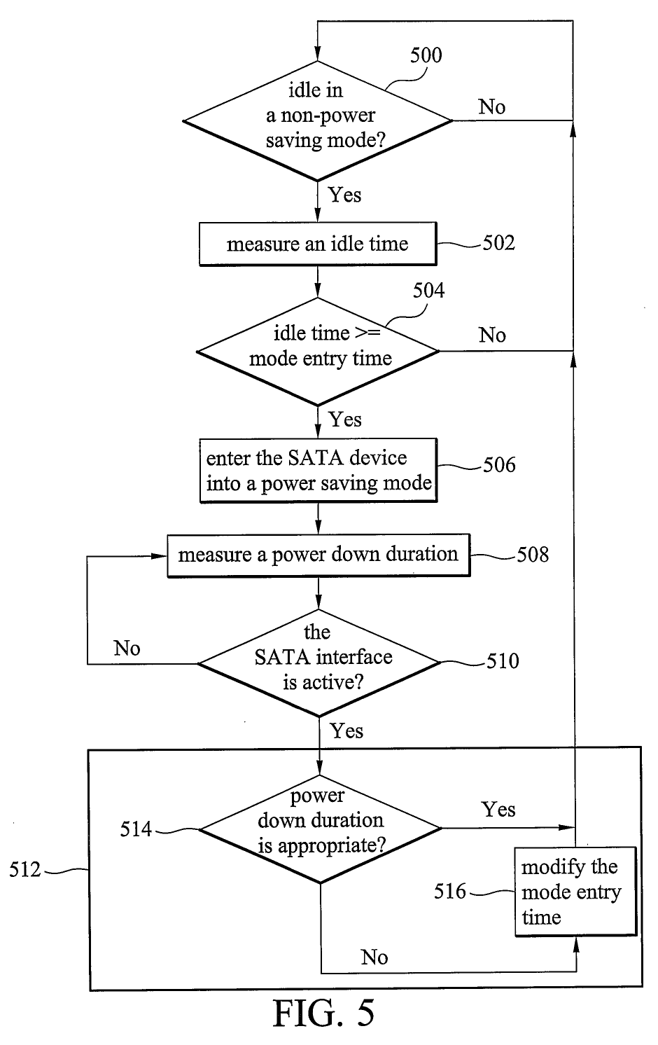

FIG. 5 is a flowchart of a method of automatic power management for a SATA compatible device according to embodiments of the invention. It is determined whether a SATA interface is idle in a non-power saving mode, as shown in step 500. If so, a timer calculating idle time is triggered. When the SATA interface returns to data transmission or reception, i.e. returns to active mode, before the idle time reaches a mode entry time, calculation of idle time is stopped and reset, then returns to step 500. As shown in step 506, if the idle time exceeds or equals a mode entry time, the SATA compatible device is switched to operate in a power saving mode and calculation of the power down duration is triggered, in step 508. When the SATA interface returns to the active mode, power down duration is stopped and determination whether the mode entry time need be modified is conducted in step 512. If the power down duration is appropriate, the mode entry time is not modified and the process returns to step 500. Otherwise, the mode entry time is modified in step 516 and then the process returns to step 500.

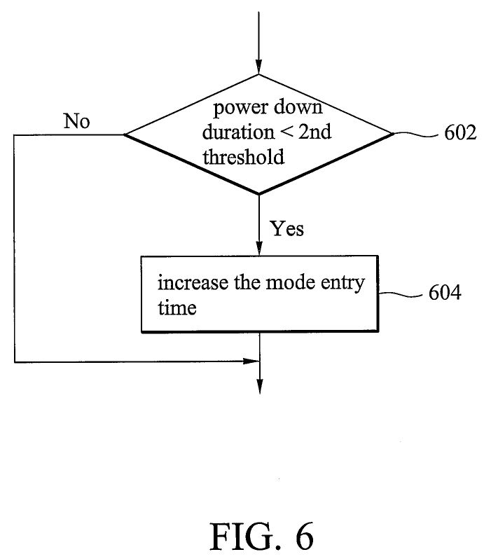

Step 512 in FIG. 5 is exemplified in FIG. 6, in which power down duration is determined to be shorter than a predetermined second threshold. If so (“Yes” route in step 602), mode entry time is increased by, for example, a predetermined number, as shown in step 604. If the power down duration is greater than the second threshold (“No” route in step 602), the mode entry time remains unchanged.

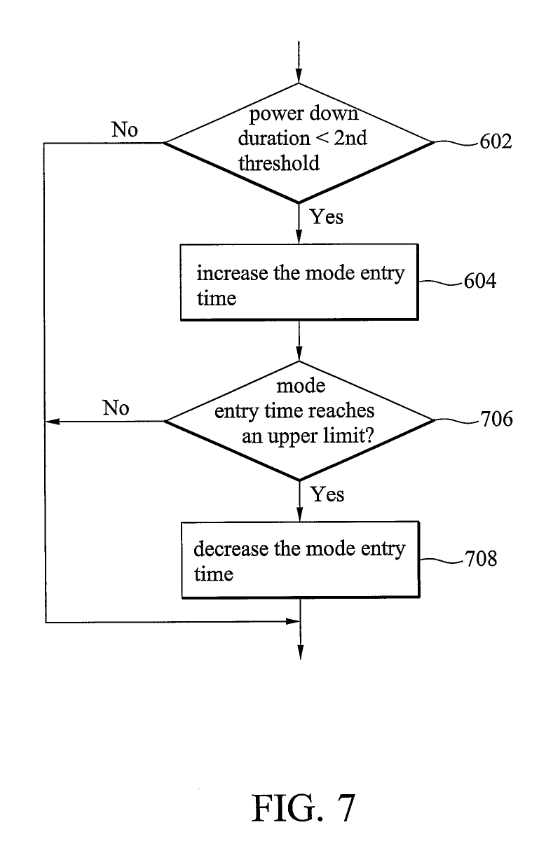

The mode entry time can be limited to avoid undesired effect by unlimited increasing of mode entry time. Accordingly, FIG. 7 shows a modified version of FIG. 6. Step 706, following step 604, step 706 determines whether the mode entry time reaches an upper limit. If so, the mode entry time is decreased, either arbitrarily or by a predetermined number, in step 708. Therefore, the mode entry time stays less than the upper limit and an idle period beyond the upper limit can be avoided.

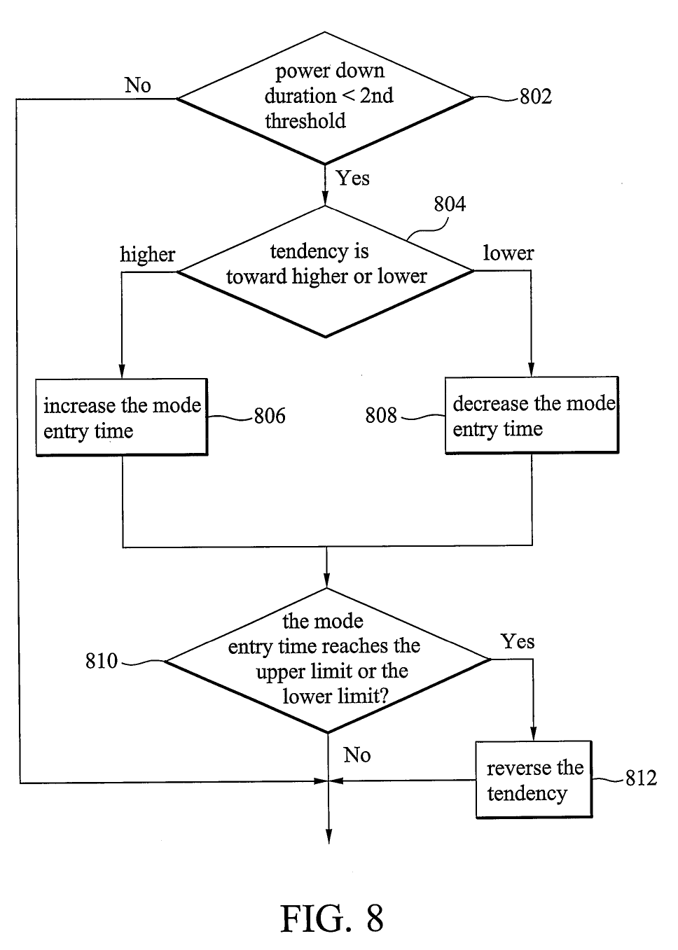

Step 512 in FIG. 5 is also exemplified in FIG. 8, in which the power down duration is determined to be too short if it is less than a second threshold. Unlike FIGS. 6 and 7, in which a too-short power down duration triggers increment of the mode entry time, a too-short power down duration in FIG. 8 may render increment or decrement of the mode entry time such that the mode entry time in FIG. 8 remains within an upper and lower limit. A tendency variable is assigned indicating the mode entry time to go higher or lower when modified. Thus, whether the power down duration is too short is determined in step 802. In step 804 it is determined whether the mode entry time tends toward the upper limit or lower limit. Step 806 follows step 804 if the mode entry time tends toward higher, such that the mode entry time is increased. Step 808 follows step 804 if the mode entry time tends toward lower, such that the mode entry time is decreased. In step 810 it is determined whether the changed mode entry time reaches an upper limit or a lower limit. If so, the tendency of the mode entry time is reversed so that the mode entry time remains between upper and lower limits.

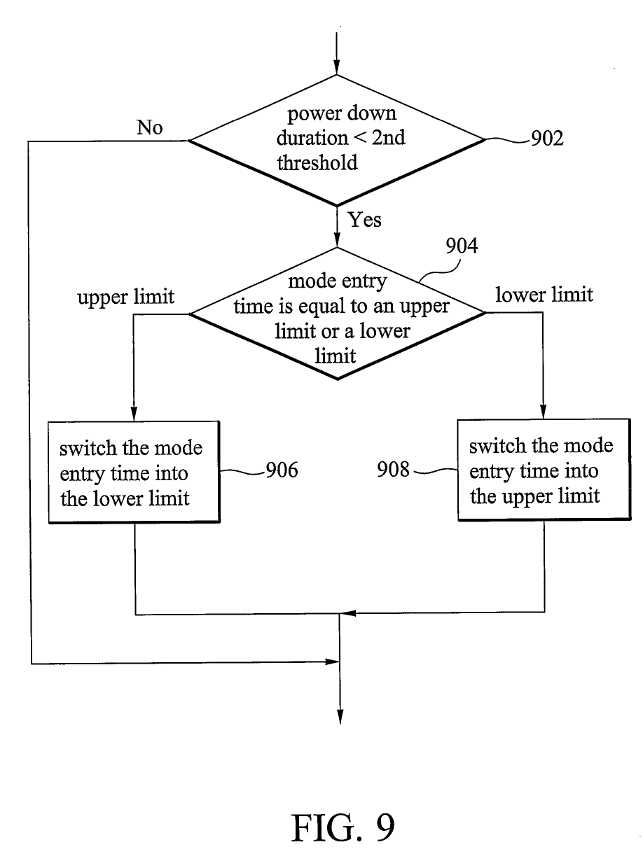

FIG. 9 shows another example of step 512 in FIG. 5, in which the mode entry time can only comprise an upper value or a lower value. If it is determined that the power down duration is too short, the mode entry time is switched from one value to the other. In Step 902 in FIG. 9 it is determined whether the power down duration is less than a second threshold. If not, the mode entry time remains unchanged. If so, in step 904 it is determined whether the mode entry time is the upper or lower value. In step 906 the mode entry time is switched from the upper to the lower value, or, in step 908, from the lower to the upper value.

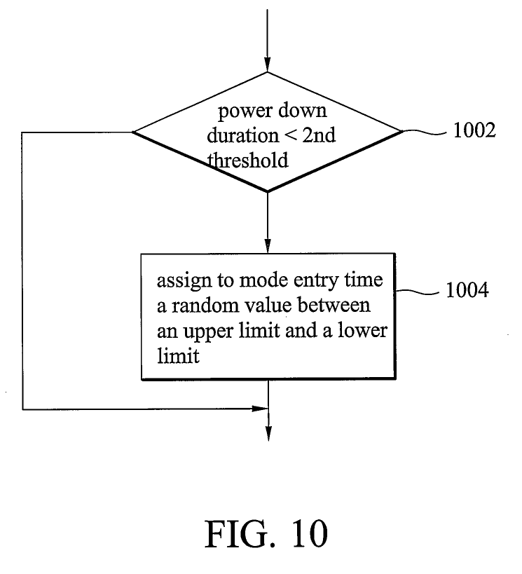

FIG. 10 shows another example of step 512 in FIG. 5. Here, in step 1004, the mode entry time is randomly assigned a value between an upper limit and a lower limit if the power down duration is determined shorter than the second threshold.

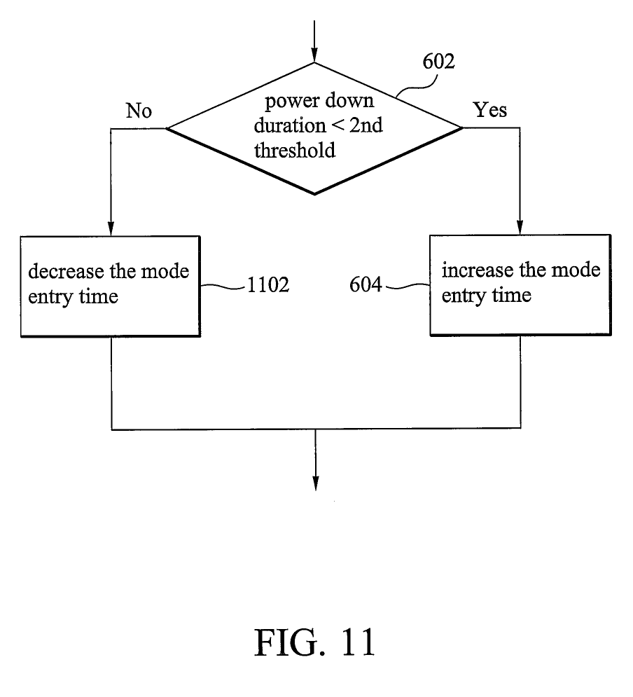

FIG. 11 differs from FIG. 6 only in the addition step 1102 following a “No” result in step 602. In step 1102, mode entry time is decreased when the power down duration not less than the second threshold, such that the SATA compatible device can be changed into power saving mode earlier for saving more power.

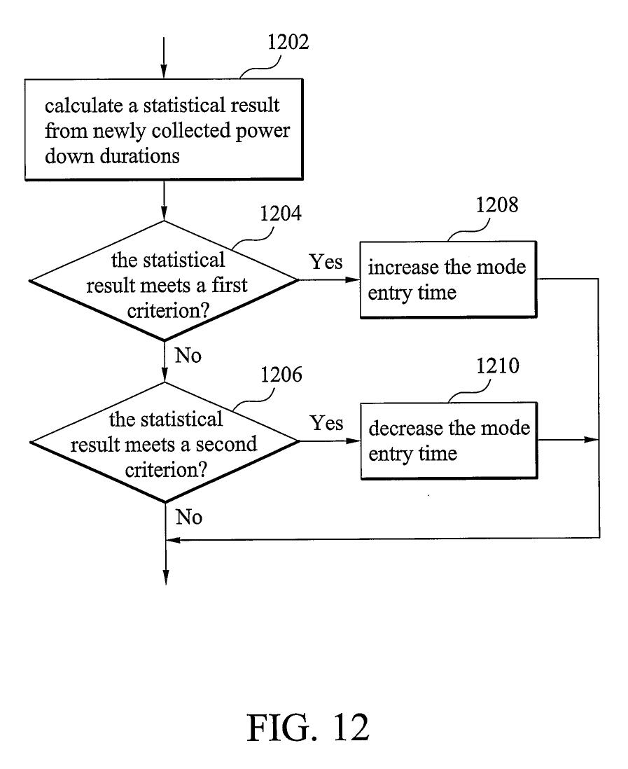

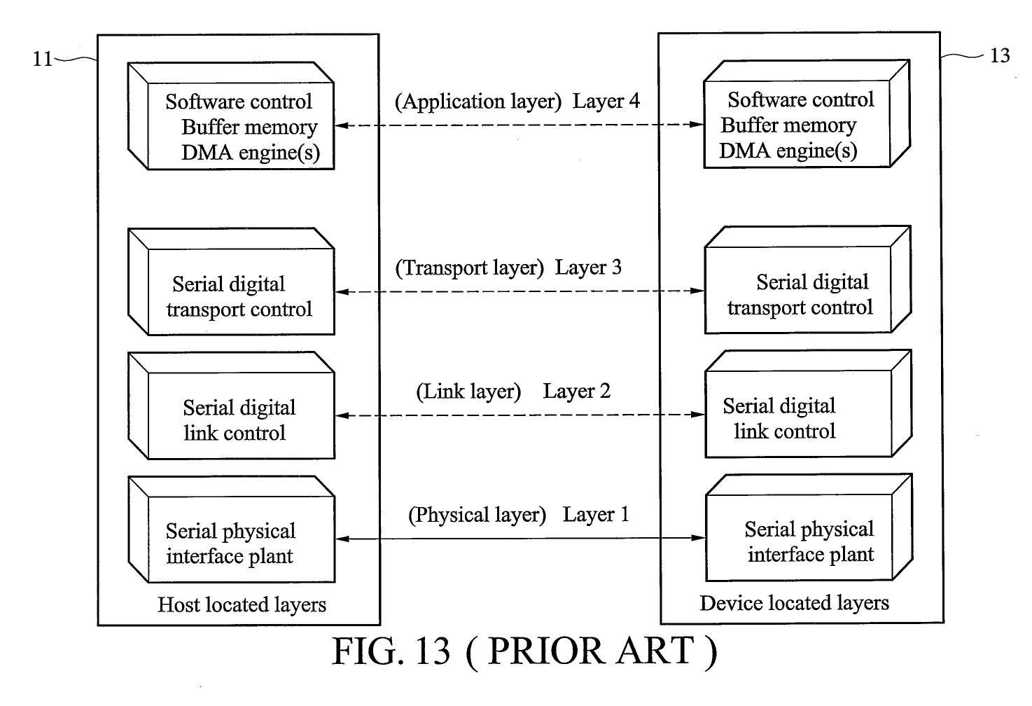

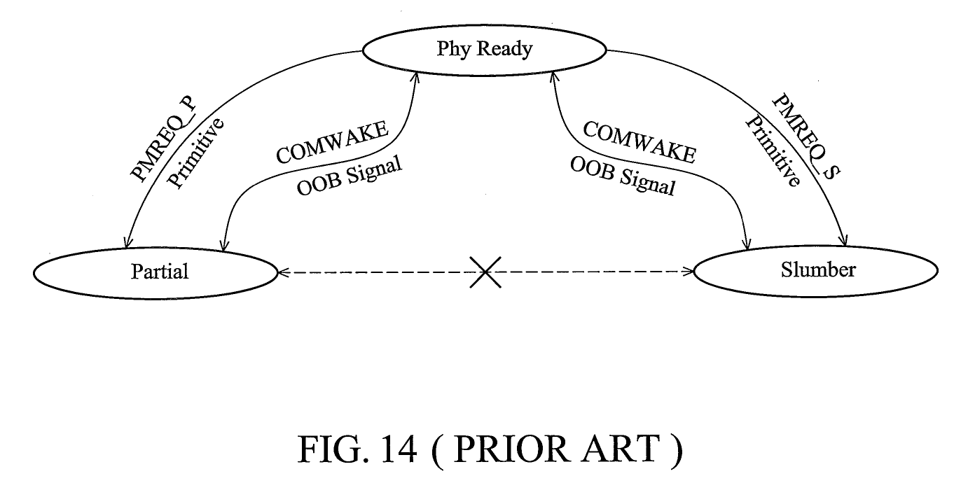

Since individual occurrences of inappropriate power down duration can be generated by a casual event, it may not be desirable to modify the mode entry time each time when any power down duration is determined to be too short or too long. Therefore, statistical results of newly collected power down durations may be introduced to justify modification method of the mode entry time, as shown in FIG. 12. In step 1202, a statistical result is calculated from newly collected power down durations. If the statistical result meets a first criterion (“yes” route in step 1204), the mode entry time is increased in step 1208. If the statistical result meets a second criterion (“yes” route in step 1206), the mode entry time is decreased in step 1210. Otherwise, the mode entry time remains unchanged.

The statistical results in FIG. 12 may be the percentage of inappropriate power down durations among a certain number of newly-collected power down durations. Or it may be the number of inappropriate power down durations during a certain period of time. For example, it may justify the increment of the mode entry time if more than 80% of every 20 newly-collected power down durations is determined to be too short. It may also justify the increment of the mode entry time if more than 10 power down durations are determined to be too short within one hour, for example. Other events are possible to justify the modification of the increment of the mode entry, such as all power down durations determined to be too short within one day, more than 8 consecutive power down durations in a predetermined period of time are determined to be too short, or the like. The criterion used to justify the increment of the mode entry time may or may not be similar with that used for justifying the decrement of the mode entry time. For example, both criteria may rely on percentage of inappropriate power down durations, or one on percentage while the other on the count of inappropriate power down durations.

The embodiments of the invention are exemplified by way of SATA interfaces, but the invention is not limited thereto. The invention would be also implemented in Serial Attached SCSI (SAS) interfaces utilizing SAS buses. For example, SATA bus 22 and SATA interfaces 16 and 18 in FIG. 1 would be replaced by a SAS bus and corresponding SAS interfaces while employing one of the power management methods disclosed in FIGS. 2a, 2b, and 5-12. SATA bus 22 and SATA interfaces 34 and 32 in FIG. 3 would be replaced by a SAS bus and corresponding SAS interfaces while employing one of the power management methods disclosed in FIGS. 4a, 4b, and 5-12.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power management method for conserving power consumption of an electronic device having a serial bus interface, the serial bus interface having an internal queue to store outstanding commands, the method comprising:
determining whether the internal queue is empty; and
switching the electronic device into a power saving mode if the internal queue is empty.

2. The power management method as claimed in claim 1, the method further comprising:
measuring an idle time when the internal queue is empty, wherein the electronic device is switched into the power saving mode when the idle time is greater than or equal to a first threshold.

3. The power management method as claimed in claim 1, the method further comprising:
switching the serial bus interface to the power saving mode if the internal queue is empty.

4. A power management method for conserving power consumption of an electronic device having a serial bus interface, the method comprising:
determining whether the serial bus interface receives or transmits a synchronization signal; and
switching the electronic device into a power saving mode if the serial bus interface receives or transmits the synchronization signal.

5. The power management method as claimed in claim 4, the method further comprising:
measuring an idle time when the serial bus interface receives or transmits the synchronization signal, wherein the electronic device is switched into the power saving mode when the idle time is greater than or equal to a first threshold.

6. The power management method as claimed in claim 4, the method further comprising:
switching the serial bus interface into the power saving mode if the serial bus interface receives or transmits the synchronization signal.

7. A power management method for conserving power consumption of an electronic device having a serial bus interface, the serial bus interface comprising a link layer portion, the method comprising:
determining whether the link layer portion is idle; and
switching the serial bus interface into a power saving mode if the link layer portion is idle.

8. The power management method as claimed in claim 7, the method further comprising:
measuring an idle time when the link layer portion is idle, wherein the electronic device is switched into the power saving mode if the idle time is greater than or equal to a first threshold.

9. The power management method as claimed in claim 7, the method further comprising:
switching the serial bus interface into the power saving mode if the serial bus interface receives or transmits the synchronization signal.

10. A power management method for conserving power consumption of an electronic system capable of operating in a non-power-saving mode and a power saving mode, the method comprising:
measuring an idle time when the electronic system is idle in the non-power-saving mode;
switching the electronic system into the power saving mode if the idle time is greater than or equal to a first threshold;
measuring a power down duration during the electronic system in the power saving mode; and
modifying the first threshold according to the power down duration.

11. The power management method as claimed in claim 10, wherein the modifying step comprises increasing the first threshold when the power down duration is less than a second threshold.

12. The power management method as claimed in claim 11, wherein the modifying step further comprises decreasing the first threshold when the first threshold reaches an upper limit.

13. The power management method as claimed in claim 10, wherein the modifying step comprises decreasing the first threshold when the power down duration is greater than a second threshold.

14. The power management method as claimed in claim 10, wherein the modifying step comprises:
increasing the first threshold when the power down duration is less than a second threshold and a tendency of the mode entry time is toward higher;
decreasing the mode entry time when the power down duration is less than the second threshold and the tendency of the mode entry time is toward lower; and
reversing the tendency of the mode entry time when the mode entry time reaches an upper limit or a lower limit.

15. The power management method as claimed in claim 10, wherein the modifying step comprises:
switching the mode entry time between an upper limit and a lower limit when the power down duration is less than a second threshold.

16. The power management method as claimed in claim 10, wherein the first threshold is decreased in the modifying step when a statistical result from newly collected power down durations meets a criterion.

17. The power management method as claimed in claim 10, wherein the first threshold is increased in the modifying step when a statistical result from newly collected power down durations meets a criterion.

18. The power management method as claimed in claim 10, wherein the modifying step comprises:
calculating a statistical result of newly collected power down durations;
increasing the first threshold when the statistical result meets a first criterion; and
decreasing the first threshold when the statistical result meets a second criterion.

19. The power management method as claimed in claim 18, wherein one of the first and second criteria is that more than a predetermined percentage value of the newly collected power down durations are determined to be inappropriate.

20. The power management method as claimed in claim 18, wherein one of the first and second criteria is that more than a determined number among the newly collected power down durations within a period of time are determined to be inappropriate.
